(19) United States
(12) Patent Application Publication
(10) Pub. No.: US 2006/0173760 A1
(43) Pub. Date: Aug. 3, 2006

(54) Computer-based management and reporting methods for tax-advantaged drilling investments

(76) Inventor: Julian P. Kornfeld, Oklahoma City, OK (US)

Correspondence Address: DUNLAP, CODDING & ROGERS P.C., PO BOX 16370, OKLAHOMA CITY, OK, 73113, US

(21) Appl. No.: 11/050,561

(22) Filed: Feb. 3, 2005

(51) Int. Cl. G06Q 40/00

(52) U.S. Cl. 705/35

(57) ABSTRACT

The present invention relates to a system and method for funding a drilling fund using the established benefits of tax deductions and/or losses associated with the drilling of oil and gas wells. More particularly, the present invention relates to a system having computer software which provides searching and documentation functions to aid in the creation, marketing, management, and reporting of the drilling fund in accordance with applicable tax laws. The system first identifies potential investors for the drilling fund based on niche investor criteria by searching though entity information to create a niche investor database. Offering materials for the drilling fund are generated by the system for each potential investor so that the drilling fund can be marketed to the potential investors. Once an interested investor invests in the drilling fund and monies are expended for drilling, the tax losses begin to flow to the interested investor. During the life of the drilling fund, reports setting forth the operational and financial progress of the drilling fund are periodically generated by the system and disseminated to the investors. Further, the system can generate other relevant documents, such as federal and state tax return schedules and forms.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF INVENTION

This country faces a severe shortage of natural gas! Witness the fact that in the past 18 months wellhead prices have increased from approximately three dollars per MMBTU to over eight dollars per MMBTU. The only way the natural gas shortage will be alleviated is through the discovery of new reserves. The major oil and gas companies have basically left the United States in search for oil in countries that impose less restrictive rules and regulations with respect to pollution, environmental, etc. Furthermore, it appears that the major oil and gas companies approach to the natural gas is to import liquified natural gas into large terminals on the coasts. Thus, the natural gas industry in the United States is basically left to the independent industry. With the exception of a few large independents like Devon, Anadarko petroleum, Chesapeake and a few others, most of the independents lack sufficient capital to drill exploratory wells deeper than 15,000 ft., which usually costs approximately $2,000,000 or more per well. Most geologists that I have come into contact with believe that the largest potential from new natural gas reserves are from formations 15,000 ft. or deeper.

Prior to changes in the federal income tax law, many independents raised capital for exploratory drilling through oil and gas drilling funds usually set up in limited partnership format. These appealed to individuals with high amounts of ordinary income from salaries, wages or commissions, such as corporate executives, doctors, lawyers, movie stars, rock stars, etc. These types of individuals would invest in oil and gas drilling funds for the intangible drilling expense deduction (roughly 75% of the cost of a well and fully deductible in the year incurred) was allocated to the investor who utilized those deductions to offset their income from other sources. Billions of dollars were raised by the independent industry in those years.

However, approximately 10 or 15 years ago, two provisions of the Internal Revenue Code were passed by Congress, one being the passive activity loss rule and the other being the alternative minimum tax. Under the passive activity loss rule, any losses from a passive activity could only be offset against income from a passive activity. Passive activity was defined as any trade or business in which the taxpayer did not materially participate. Investments in limited partnerships were automatically considered as a passive activity. Very few people had passive activity income since interest and dividend income was not considered passive activity income under the passive activity loss rule.

There is a limited exception for an investment in a working interest in an oil and gas property where the taxpayer holds it either directly or through an entity which does not limit the liability of the taxpayer with respect to such interest. Basically, this means that if one invests as an individual or through a general partnership, both of which would involve potential unlimited liability, the passive activity loss rule would not apply. However, due to the potential for liability in the oil and gas industry, no one that is knowledgeable would invest as an individual or through a general partnership since they would effectively be trading their net worth for a tax deduction.

The other deterrent to the raising of capital for the independent oil and gas industry, is the alternative minimum tax rule whereby productive well intangible drilling expense is added back for the purpose of calculating alternative minimum taxable income. There is an exception, but one cannot reduce alternative minimum taxable income by more than 40% by the use of the exception.

The effect of these two provisions in the Internal Revenue Code has substantially curtailed outside capital to the independent oil and gas industry. The new American Jobs Creation Act of 2004, recently signed by the President, does not appear to alleviate either of the above that tax impediments.

Thus, there is a need for a system for enhancing investments into oil and gas drilling funds to stimulate exploratory drilling in the United States. The present invention is directed to a system for marketing the classic functionally allocated oil and gas drilling funds to a special niche group of investors, whereby these types of investors would be exempt from both the alternative minimum tax and the passive activity loss rule because of specific language within the Internal Revenue Code.

### SUMMARY OF THE INVENTION

In general, the object of the present invention is to provide a method for facilitating the funding of exploratory and/or developmental drilling expeditions using the established benefits of tax deductions and/or losses associated with the drilling of oil and gas wells.

In one embodiment of the present invention, a system having computer software provides searching and documentation functions to aid in the creation, marketing, management, and reporting of a drilling fund in accordance with applicable tax laws. The system first identifies potential investors for the drilling fund based on “niche investor criteria,” as determined utilizing the Internal Revenue Code of 1986, as amended, and in particular Sections 55(e)(1)(A) and 469)(c)(3).

The potential investors are preferably identified by searching a database containing entity information associated with a plurality of entities to determine if an entity matches the niche investor criteria. Offering materials for the drilling fund, such as an offering circular, a tax opinion, and a draft agreement are generated by the system for each potential investor so that the drilling fund can be marketed to the potential investors. Once at least one interested investor, and preferably a plurality of interested investors, agree to finance the drilling fund to a desired amount, the drilling fund is established. The drilling fund is preferably established as a general partnership by executing a partnership agreement generated by the system. During the life of the drilling fund, reports setting forth the operational and financial progress of the drilling fund are periodically generated by the system and disseminated to the investors. Further, the system can generate other relevant documents, such as federal and state tax return schedules and forms.

### BRIEF DESCRIPTION OF THE SEVERAL VIEWS OF THE DRAWINGS

FIG. 1 is a block diagram of a system and method for funding a drilling fund in accordance with the present invention.

FIG. 2 is a flow chart of the steps employed in one preferred method of the present invention.

FIG. 3 is a block diagram of a computer based management system for a drilling fund, constructed in accordance with the present invention.

### DETAILED DESCRIPTION OF THE INVENTION

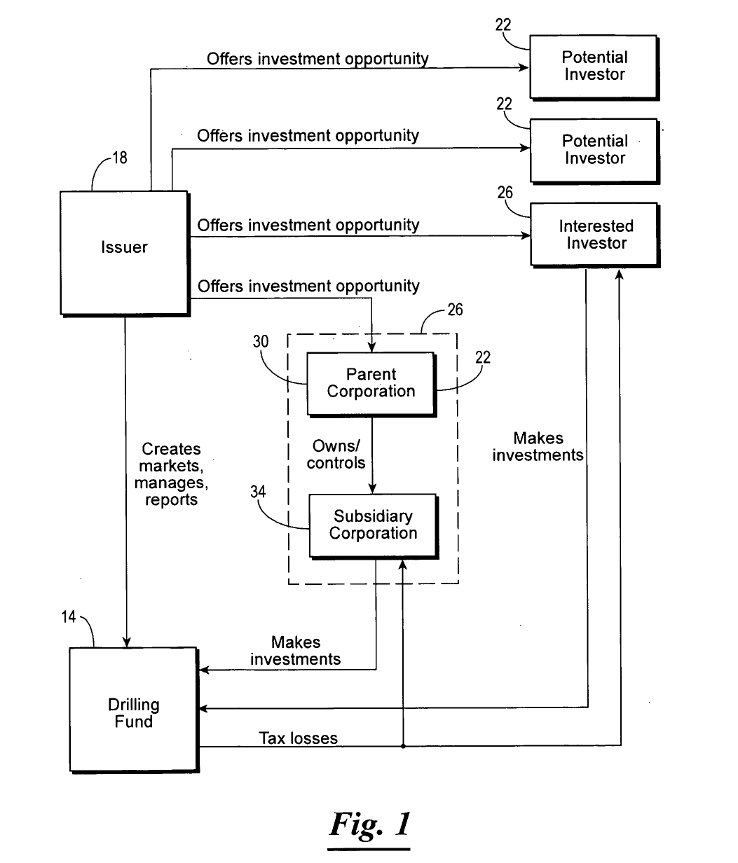

Referring now to the drawings, more particularly FIG. 1, shown therein and designated by a reference numeral 10 is a system for funding a drilling fund 14. In general, the drilling fund 14 is a unique business entity with a business purpose of drilling for oil, gas, or other resources. Business activities conducted by the drilling fund 14 can include for example funding and/or conducting exploratory and developmental drilling of geological prospects. Due to the nature of the business activities, the drilling fund 14 generally has losses and tax deductions which are usable by its owners in accordance with applicable tax codes and regulations. The provisions of the tax laws used to model a preferred embodiment of the present invention include Sections 55(e)(1)(A) and 469(c)(3) of the Internal Revenue Code of 1986, as amended.

In order to satisfy the current requirement of Section 469(c)(3), which specifies that the owners of the entity claiming the tax benefit not be exempted from liability, the drilling fund 14 is preferably set up as general partnership in accordance with the applicable laws of the state in which the partnership is to be established and governed. However, the drilling fund 14 can have any business structure that imposes liability on its owners so as to meet Section 469(c)(3), in accordance with the present invention. Further, if such a limitation is removed or amended in the applicable tax laws, the business structure of the drilling fund 14 can be adjusted accordingly.

In order to satisfy the current requirements of Section 55(e)(1)(A), which specifies the exemption from the Alternative Minimum Tax, an owner of the drilling fund 14 (shown in FIG. 1 as including an issuer 18 and a plurality of interested investors 26) should be a corporation entity with average annual gross receipts for all three year periods ending before the taxable year of investment in the drilling fund 14 of not more than $7.5 million, and should have been exempt from the Alternative Minimum Tax for at least one taxable year prior to the year of investment in the drilling fund 14. (The term “Alternative Minimum Tax” refers to the tax imposed pursuant to Sections 55-59 of the Internal Revenue Code of 1986, as amended.) However, if such limitations are removed or amended in the applicable tax laws, the required characteristics of the owners of the drilling fund 14 can be adjusted accordingly.

Preferably, an owner of the drilling fund 14 is a corporation (other than an “S corporation”) having the required characteristics described above, or a subsidiary corporation (other than an “S corporation”) which at least 80% of the total voting power and value of its stock is owned by a parent corporation having the required characteristics. (The term “S corporation” generally refers to a corporation defined in Section 1361 of the Internal Revenue Code of 1986, as amended.) The subsidiary arrangement is preferred to limit the liability of the parent corporation to the capital investment made by the subsidiary to the drilling fund 14, in accordance with applicable state and federal laws. The parent corporation sets up and funds the subsidiary corporation such that the subsidiary corporation actually makes the investment into the drilling fund 14. Thus, the maximum liability to the parent corporation is the amount of the investment. Then, by filing consolidated federal income tax returns by the parent and subsidiary corporations, pursuant to Sections 1501-1505 of the Internal Revenue Code of 1986, as amended, and applicable Treasury Regulations thereunder, the losses of the subsidiary will offset income of the parent corporation.

In one preferred embodiment, the issuer 18 facilitates the creation, marketing, management, and reporting of the drilling fund 14. Preferably, the issuer 18 is an entity, such as a company or subsidiary thereof, which actively manages the business and operation of the drilling fund 14. Preferably, the issuer 18 also provides a non-capital contribution to the drilling fund 14. Such non-capital contribution can include such assets as drilling equipment and leases, for example. Although the drilling fund 14 is discussed generally herein with reference to being created, marketed, managed and reported on by the issuer 18, it should be understood that such processes, or portions thereof, can be performed by another entity (or entities) in accordance with the present invention.

In general, the issuer 18 identifies the expected capital needs of the drilling fund 14. Then, the issuer 18 (or a marketer thereof) offers opportunities for investing in the drilling fund 14 to a plurality of potential investors 22 in order to meet the expected capital. A potential investor 22 which agrees to invest in the drilling fund 14 is referred to herein as an interested investor 26. Once the interested investor 26 makes the investment, in one payment or a series of payments and the drilling fund 14 begins expending monies in the drilling of oil and/or gas wells, the tax losses begin to accrue.

Also, a potential investor 22 which is a corporation can set up a subsidiary corporation to make the investment in the drilling fund 14, as discussed above. Such an arrangement is shown in FIG. 1, wherein a parent corporation 30 owns a subsidiary corporation 34. For purposes of describing the present invention, in such an arrangement the parent corporation and the subsidiary corporation are referred to and shown in FIG. 1 collectively as one of the interested investors 26.

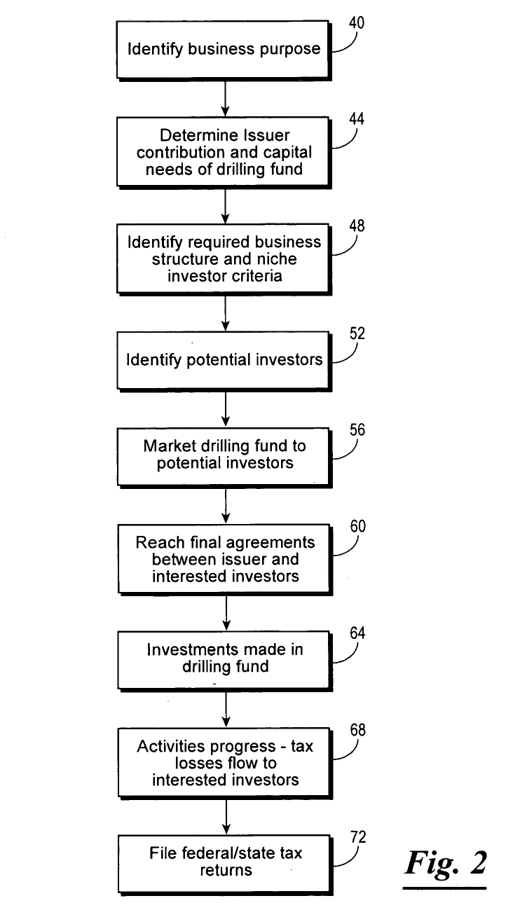

Referring now to FIG. 2, shown therein is a flow chart for a preferred implementation of a method for managing the drilling fund 14 over the “life” of the drilling fund (i.e., from the creation or inception of the drilling fund 14 to the termination of the drilling fund 14). In a first step 40, the issuer 18 identifies a business purpose for the drilling fund 14 by determining what activities the drilling fund 14 will endeavor. For example, the issuer 18 can determine that the drilling fund 14 will conduct an exploratory drilling expedition for oil on an established lease for property located in Oklahoma.

Based on the business purpose, the issuer 18 can then determine the value of its expected contribution to the drilling fund 14, as well as the additional expected capital needs for the drilling fund 14, as shown in step 44. Such a determination can be based on data accumulated from past projects, estimated costs associated with the nature, extent, location and duration of the proposed activities, etc.

In a next step 48, the issuer 18 identifies the required business structure for the drilling fund 14, according to the applicable tax laws. As discussed above, the current business structure is preferably a general partnership. In this step, the issuer 18 also identifies the required characteristics for the owners of the drilling fund 14 to qualify for tax benefits in accordance with the applicable tax laws. As discussed above, the current owner characteristics include having average annual gross receipts for all three year periods ending before the taxable year of investment in the drilling fund 14 of not more than $7.5 million, and having been exempt from the Alternative Minimum Tax for at least one taxable year prior to the year of investment in the drilling fund 14. The owner characteristics define the “niche investor” criteria that must be met by any interested investor 26 investing in the drilling fund 14.

Based on the niche investor criteria, the issuer 18 in a step 52 identifies the plurality of potential investors 22 which are qualified to be owners of the drilling fund 14 and gain the tax benefits associated therewith. Once identified, the drilling fund 14 is marketed to each of the potential investor 22 in a step 56, i.e., each potential investor 22 is presented with marketing materials and asked to invest in the drilling fund 14. The main goal of the issuer 18 in the step 56 is to find at least one potential investor 22, and preferably a plurality of potential investors 22, to become interested investors 26 and invest enough capital to meet the expected capital needs of the drilling fund 14.

In a step 60, the interested investors 26 and the issuer 18 reach final, written, and enforceable agreements on the partnership and on the contribution or dollar amount of investment to be made over the course of the transaction by the parties. In a step 64, each interested investors 26 makes its investment in the drilling fund 14. Then as the activities of the drilling fund 14 progress, the tax losses flow back from the drilling fund 14 to each interested investor 26, as shown in step 68. The amount of tax losses to be received by each interested investor 26 is generally based on the part or percentage of the investment made by the interested investor 26 in the drilling fund 14.

Each interested investor will report its tax transactions to the appropriate federal and state tax authorities, as shown in step 72. At this time, the tax losses are taken advantage of and the benefits to the interested investor 26 are realized. In other words, the tax losses can be seen by the interested investor 26 as an after-tax “return on the investment.”

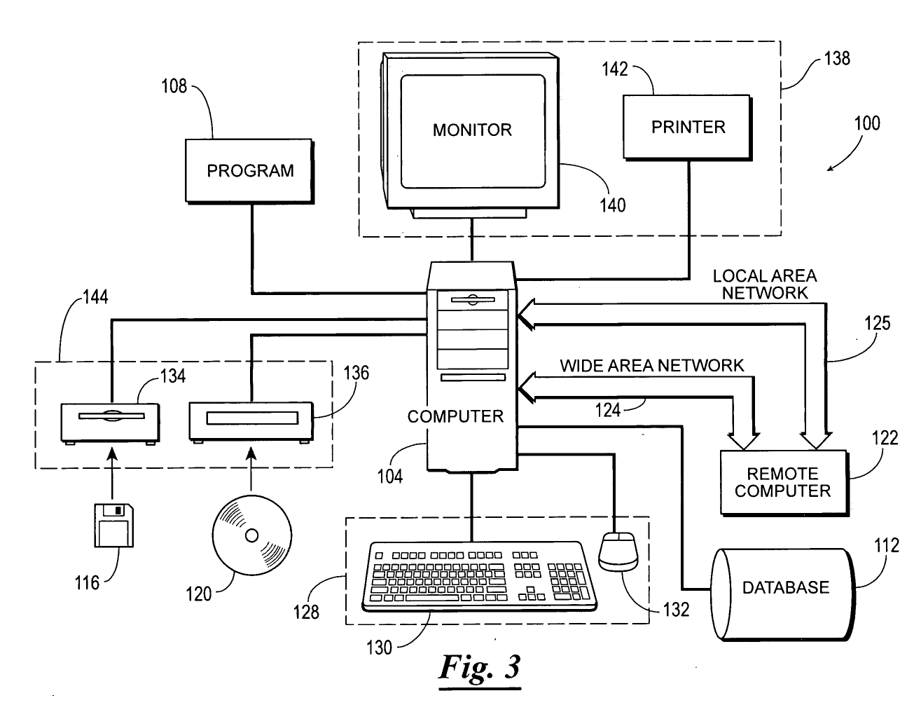

Referring now to FIG. 3, shown therein in block diagram form is one embodiment of a management system 100 which can be utilized to create, market, manage, and/or report on the drilling fund 14. The management system 100 includes a computer 104, a program 108, and a database 112. The program 108 is accessible by the computer 18. For example, the program 108 can be stored on an internal memory of computer 104. However, the program 108 (or portions thereof) can also be stored externally on a computer readable medium, such as for example on a floppy disk 116, a CD 120, or the like. Alternatively, the program 108 can be stored remotely from the computer 104 and accessed by the computer 104 via the internet or other network connection. For example, the program 108 can be stored on a remote computer 122 (e.g. a website host computer or a LAN computer) connected to the computer 104 via a WAN connection 124 and/or a LAN connection 125. Likewise, the database 112 is also accessible by the computer 104, and can be locally or remotely disposed.

The management system 100 further includes at least one input device 128 (such as a keyboard 130 and a mouse 132) and at least one output device 138 (such as a monitor 140 and a printer 142). The management system 100 can also include at least one input/output device 144 (such as a magnetic disk drive 134 and an optical disk drive 136).

Preferably, the management system 100 is primarily hosted by the issuer 18, and therefore will be discussed generally herein with reference to the issuer 18. However, it should be understood that the management system 100 can be hosted by another entity (or entities) in accordance with the present invention. Further, although the management system 100 is generally discussed herein for purposes of clarity with reference to the creation, marketing, management, and reporting of one drilling fund 14, it should be apparent to one of ordinary skill in the art that the present invention contemplates that the management system 100 can be used for a plurality of drilling funds 14.

As discussed above, a first step taken by the issuer 18 is to identify a business purpose for the drilling fund 14. In one embodiment, the program 108 facilitates this process by receiving project information indicative of a description of a business purpose and proposed activities for the drilling fund 14. Such project information preferably includes information relating to the nature, extent, location and duration of the proposed activities for the drilling fund 14. For example, the issuer 18 can provide such project information to the program 108 via the computer 104 and the at least one input device 128. The program 108 then stores the project information, preferably on an internal or network memory of the computer 104, so as to maintain a record of the project information for the drilling fund 14. Further, the program 108 can receive issuer-contribution information indicative of a description and/or value of the expected contribution of the issuer 18 to the drilling fund 14. Also, the program 108 can receive information of, or calculate, the additional expected capital need for the drilling fund 14. For example, the program 108 can calculate the expected capital need based on the project information received and a predetermined formula and/or data provided from past projects.

To facilitate the issuer 18 in identifying the required business structure for the drilling fund 14, and setting up the drilling fund 14 accordingly, the program 108 can receive structure information indicative of the required business structure. As discussed above, the current business structure is preferably a general partnership, as based on the applicable tax laws. The structure information can be provided to the program 108 by the issuer 18 (e.g., via the computer 104 and the at least one input device 128). However, the structure information can also be predefined in the program 108 or retrieved by the program 108. Further, to stay current, the program 108 can periodically or continuously monitor the applicable tax codes (e.g., via the internet) and alert the issuer 18 of any changes and/or update the required business structure accordingly.

Also, the structure information can include information indicative of the state in which the drilling fund is to be established. Based on such information, the program 108 can then determine the elements of formation required by the state for the desired business structure, such as for example by searching a database containing such information. Also, the program 108 can utilize such information to generate establishing documents, such as a partnership agreement (as discussed further below).

In one preferred embodiment, the program 108 facilitates in the identifying of potential investors 22. The program receives criteria information indicative of the niche investor criteria that must be met by an owner of the drilling fund 14 to qualify for tax benefits in accordance with the applicable tax laws. As discussed above, the current owner characteristics include having average annual gross receipts for all three year periods ending before the taxable year of investment in the drilling fund 14 of not more than $7.5 million, and having been exempt from the Alternative Minimum Tax for at least one taxable year prior to the year of investment in the drilling fund 14, as based on the applicable tax laws. The criteria information can be provided to the program 108 by the issuer 18, or predefined in or retrieved by the program 108. Further, to stay current, the program 108 can periodically or continuously monitor the applicable tax codes (e.g., via the internet) and alert the issuer 18 of any changes and/or update the criteria information accordingly.

Once the criteria information is received, the program 108 searches through entity information indicative of the characteristics of a plurality of entities (which are preferably corporations other than S corporations) to identify the potential investors 22 for the drilling fund 14. Such characteristics can include for example a name, status identifier (e.g, “Inc.”, “Corp.”, “LLC”, etc.), industry (e.g., “service industry”, “manufacturing”, etc.), address, net worth, gross receipts, assets, holdings, etc. The program 108 can search through a database having entity information which is hosted by the issuer 18, or the program 108 can search through a linked third party database, such as one hosted by a credit institution or independent evaluator (e.g., Dun & Bradstreet Corporation).

Once an entity is determined by the program 108 to meet the niche investor criteria, the program 108 then stores the entity information corresponding to the entity in the database 112 of the management system 100, which is also referred to herein as the “niche investor database.” The issuer 18 can then select the potential investors 22 from the niche investor database 112 for which investment opportunities in the drilling fund 14 will be offered and marketed. Further, to facilitate in the marketing process, the program 108 can rank the potential investors 22 in the niche investor database 112, such as for example based on net worth, industry, record of investment, etc. Also, the niche investor database 112 can be periodically updated so as to stay current, especially when the database 112 is also used to market future drilling funds 14.

In one preferred embodiment, the program 108 facilitates the marketing process by generating marketing materials for each potential investor 22. The program 108 utilizes the project information associated with the drilling fund 14 and/or the entity information associated with one of the potential investor 22 to generate the marketing materials for the potential investor 22. This allows customized marketing packages to be efficiently generated, especially when multiple drilling funds are marketed to multiple potential investors 22.

Preferably, the marketing materials include an offering circular, a tax opinion, a partnership agreement, and a subscription agreement. Other marketing materials can also be included. In general, the offering circular is a document which sets forth a description of the drilling fund 14, the nature of its business to be conducted, the risk factors incident to an investment in the drilling fund 14, the tax implications of the investment, and any other subject matter that is necessary for a potential investor 22 to make an informed decision to invest or not to invest in the drilling fund 14. Generally, the offering circular is provided to the potential investor 22 prior to the execution of the partnership agreement and/or the subscription agreement. The tax opinion is a document setting forth the opinion of a qualified tax attorney which details the federal income tax aspects of an investment in the drilling fund 14. The partnership agreement is a document which sets forth the terms and conditions to which the signing parties agree to be bound under the partnership. The subscription agreement is a document which sets forth the agreed upon contribution to the capital of the drilling fund 14 by the signing party, and is generally in terms of a specific dollar amount and payment time frame.

The contents for any portion of the marketing documents can be generated by the program 108. The program 108 can generate one of the documents based on stored templates and user selections or other input (e.g., the project information). For example, the program 104 can generate a subscription agreement for one of the potential investors 22 based on a stored template having an entry field for the amount of investment which is inputted by the issuer 18 (e.g., via the computer 104 and the keyboard 130) or calculated by the program 108 (e.g., based on the cash flow required for the drilling fund 14 and an estimated number of participating investors). Also, the content can be provided to the program 108, e.g. by inputting or scanning in a document via the computer 104 and the at least one input device 128. For example, a preconstructed subscription agreement can be scanned via the computer 104 and a scanner (not shown) so as to create a data file accessible by the program 108 so that the subscription agreement can be included in the marketing materials package generated by the program 108.

The various marketing documents are assembled by the program 108 so as to generate the marketing materials in the form of at least one data file. The marketing materials data file can be stored by the program 108 and/or outputted in a format perceivable by a human, such as via the computer 104 and the monitor 140 or the printer 142. Then the marketing materials can be distributed and presented to the potential investors 22 by the issuer 18 (or an associated marketer), such as via an email, website posting, postal mail, personal delivery, etc.

Once at least one potential investor 22, and preferably a plurality of potential investors 22, agrees to invest in the drilling fund 14 (and thus become interested investors 26), finalized partnership and subscription agreements are executed. Preferably, a copy of the finalized partnership and subscription agreements are received and stored by the program 108. Such copies serve as a recording of the agreements which can be later accessed and reproduced if desired. Also, such documents can be utilized by the program 108 to generate the necessary documents (if any) which must be filed with the state in which the drilling fund 14 is established.

The program 108 also receives investor information indicative of the investment made by each interested investor 26 in the drilling fund 14. Preferably, such investor information includes identifying information for the interested investor 26 (e.g., a name or reference number), and the amount and date(s) of expected and/or received investment contributions. Other information can also be provided and/or retrieved by the program 108, such as the entity information corresponding to the interested investor 26 from the niche investor database 112, for example.

As discussed above, a subsidiary arrangement is preferred to limit the liability of a parent corporation (the parent corporation 30 and the subsidiary corporation 34 acting as one of the interested investors 26 is shown in FIG. 1). Thus, if the subsidiary corporation 34 is created by the parent corporation 30 to make the investment into the drilling fund 14, the program 108 preferably stores information for both the subsidiary corporation 34 and its related parent corporation 30. The niche investor database 112 can also be updated to include information indicative of the subsidiary arrangement. Also, in one embodiment, the program 108 can generate the necessary documents (if any) which must be filed with the state to establish the subsidiary corporation 34.

Once the interested investor 26 makes the investment and monies are expended for drilling, the tax losses begin to accrue. Also, when the interested investor 26 has invested in the drilling fund 14, the entity information associated with that interested investor 26 in the niche investor database 112 can be updated to include information indicative of the investment made by the interested investor 26. Further, if a potential investor 22 declines the offer, the entity information associated with that potential investor 22 in the niche investor database 112 can be updated to include information indicative of the declination made by the interested investor 26. Such information can be used for example when future investment opportunities and drilling funds are marketed.

In one preferred embodiment, as the activities of the drilling fund 14 progresses, the program 108 generates periodic progress reports which set forth the operational or financial progress of the drilling fund 14. The progress reports can then be disseminated to the interested investors 26. For example, the progress reports can be generated on a quarterly basis and sent manually, i.e., printed off and mailed, or sent electronically via email, or made accessible via a website, to the interested investors 26.

To generate the progress reports, the program 108 includes an accounting mechanism which accounts for all receipts and disbursements of money and property to and from the drilling fund 14. The accounting mechanism can further generate balance sheets, profit and loss statements, cash flow statements, etc.

The program 108 receives accounting information for the drilling fund 14, which includes information of the investment transactions by the interested investors 26, as well as all receipts and disbursements of money or property by the drilling fund 14. The accounting information can be provided to the program 108 by the issuer 18 (e.g., via the computer 104 and the at least one input device 128). Also, the program 108 can retrieve the accounting information electronically from a predetermined location (e.g., from an electronic banking statement via the internet).

Based on the accounting information, the program 108 can automatically determine or calculate the appropriate allocation of revenue and expenses to the accounts of the issuer 18 and interested investors 26 associated with the drilling fund 14. Preferably, the allocation of expenses depends on whether the expense is currently deductible for federal income tax purposes or currently required to be capitalized for federal income tax purposes. The currently deductible expenses are allocated to the capital accounts of the interested investors 26, and the capitalized expenses are allocated to the capital account of the issuer 18. Preferably, revenues, such as the proceeds from the sale of products (e.g., oil or gas), which are produced by the activities of drilling fund 14 are allocated proportionately between the capital accounts of the interested investors 26 and the capital accounts of the issuer 18. For example, there can be a 50% distribution to the interested investors 26 and a 50% distribution to the issuer 18. Further, the interested investors' distribution is preferably distributed proportionately among the interested investors 26 according to an investment percentage of each interested investor 26.

The accounting information and allocations, or portions thereof, can be included in the progress reports. In addition, the program 108 can generate and disseminate checks to each of the interested investors 26 for its share of the revenue. Further, after the close of a taxable year of the drilling fund 14, and before the date set for tax filings, the program 108 can calculate and generate a federal and/or an appropriate state tax return required to be filed by the drilling fund 14 with respect to its income and expenses for each year of its existence. Also, the program 108 can calculate and generate applicable schedules reporting the applicable tax deductions and/or losses for each of the interested investors 26 for use in the preparation of its federal and/or state income tax returns. The schedules can then be disseminated to the interested investors 26, for example via email or a website, and/or hard copies by postal mail.

Further, the program 108 can provide other tools accessible by the interested investors 26 to facilitate the dissemination of information relating to the drilling fund 14 or communication with the issuer 18. For example a “Frequently Asked Questions” website or a direct “Help” email line can be made accessible to the interested investors 26. Such tools can also be made available to other entities as well, such as the potential investors 22.

Once the drilling fund 14 terminates or expires, the program 108 can further generate a termination document recording the termination of the drilling fund. The termination document can include information such as the date of termination, the results of the liquidation assets, etc. The termination document can be saved, outputted, and/or disseminated to the interested investors 26. Further, the program 108 can generate and disseminate checks to each of the interested investors 26 in an amount corresponding to part, or all, of the remaining capital investment of the interested investor 26. Alternatively, if the interested investor 26 desires, the program 108 can roll the amount over into a new investment. Also, the entity information associated with each interested investor 26 in the niche investor database 112 can be updated to include information indicative of the termination of the drilling fund 14 in which the potential investor 22 participated so that such information can be used, such as for example when future investment opportunities and drilling funds are marketed.

From the above description, it is clear that the present invention is well adapted to carry out the objects and to attain the advantages mentioned herein, as well as those inherent in the invention. Although the foregoing invention has been described in some detail by way of illustration and example for purposes of clarity of understanding, it will be apparent to those skilled in the art that certain changes and modifications may be practiced without departing from the spirit and scope thereof, as described herein.

What is claimed is:

1. A method of funding a drilling fund, comprising the steps:
identifying a general partnership opportunity for the drilling fund;
identifying a plurality of potential corporate investors for the general partnership, wherein each potential corporate investor has characteristics matching predetermined niche investor criteria to avoid the alternative minimum tax determined by the internal revenue code; and
executing a general partnership agreement with a subsidiary of at least one of the potential corporate investors that agrees to provide a capital investment to fund the drilling fund through the subsidiary.

2. A method for funding a drilling fund, comprising the steps of:
searching a computer database for a plurality of potential corporate investors having characteristics matching niche investor criteria for avoiding the alternative minim tax determined by the internal revenue code.

3. The method of claim 2, further comprising the step of:
automatically generating, for at least one of the potential corporate investors, marketing materials related to the drilling fund.

4. The method of claim 2, further comprising the steps of:
receiving investor information indicative of an investment by at least one interested corporate investor in the drilling fund; and
automatically generating, for each interested investor, periodic reports relating to the operational activity of the drilling fund.

5. The method of claim 4, further comprising the steps of:
receiving investor information indicative of an investment by at least one interested corporate investor in the drilling fund; and
automatically generating, for each interested corporate investor, a tax schedule relating to the investment of the interested corporate investor in the drilling fund.

6. A computer system for a drilling fund comprising:
logic to receive niche investor criteria identifying characteristics of corporations not subject to the alternative minimum tax determined by the internal revenue code;
logic to search a database containing entity information so as to identify potential corporate investors having characteristics matching the niche investor criteria;
logic to generate, for at least one of the potential corporate investors, marketing materials for an investment in the drilling fund;
logic to receive investor information indicative of an investment by at least one interested corporate investor in the drilling fund;
logic to track operational and financial activity associated with the drilling fund;
logic to direct periodic payments to each interested corporate investor if payments are due;
logic to generate, for each interested corporate investor, periodic reports relating to the operational activity of the drilling fund.

7. The computer system of claim 6 further comprising logic to generate, for each interested corporate investor, periodic tax schedules relating to the investment of the interested corporate investor in the drilling fund.
